(19) United States
(12) Patent Application Publication
(10) Pub. No.: US 2008/0016577 A1
(43) Pub. Date: Jan. 17, 2008

(54) SYSTEM AND METHOD FOR DIGITAL RIGHTS MANAGEMENT

(76) Inventors: David Elliot GOLDFARB, Beit Shemesh (IL); Jonathan William MEDVED, Jerusalem (IL)

Correspondence Address: DANIEL J SWIRSKY, 55 REUVEN ST., BEIT SHEMESH, 99544, IL

(21) Appl. No.: 11/773,417

(22) Filed: Jul. 4, 2007

Related U.S. Application Data
(60) Provisional application No. 60/818,301, filed on Jul. 5, 2006.

(51) Int. Cl. H04L 9/32

(52) U.S. Cl. 726/26

(57) ABSTRACT

A system includes a digital rights management unit to identify a trigger associated with an owner of content and a media player to display the content on a device of a viewer upon instruction from the digital rights management unit.

### CROSS-REFERENCE TO RELATED APPLICATIONS

This application claims benefit from U.S. Provisional Patent Application No. 60/818,301, filed Jul. 5, 2006, which is hereby incorporated in its entirety by reference.

### FIELD OF THE INVENTION

The present invention relates to digital rights management generally and to such management for shared personalization content in particular.

### BACKGROUND OF THE INVENTION

There are many instances where someone may want to buy content, such as stories, music, movies, etc., and to give it to someone else. In the physical world, the person has to give his physical copy to the other person. However, in the digital world (the internet, World Wide Web, etc.), there is no need to give physical copies and there exist many platforms for copying content.

Digital rights management (DRM) technologies seek to prevent unauthorized redistribution of legally purchased content. To do so, they encrypt digital works such that only those who buy the work may decode it. The encryption may include conditions on the viewing, such as the number of times or the length of time that the person may view the content before the license expires.

Copyright holders generally utilize DRM technologies to ensure that they get paid for their content. Once a person has paid for the license, s/he is free to view the content within the rights granted by the license. However, s/he is not free to pass the content on to others.

Digital video sharing has recently become common. Websites, such as YouTube, allow users to easily share videos with other users who visit their sites.

FIG. 1, to which reference is now made, illustrates a media content sharing system 100 described in U.S. patent applications 60/771,883 and 60/772,564, now incorporated into U.S. Ser. No. 11/544,938, which applications are assigned to the common assignee of the present application and are incorporated herein by reference.

FIG. 1 shows a communication device 110, owned by, for example, Jack, and a telephone 120, owned by, for example, Jill, who are simultaneously setting up or using a voice connection 140 for a telephone conversation. Jack and Jill are members of a content sharing community 150 and use a community server 130 for the selection and download of content, such as media clips (which may include video clips, audio clips, etc.), to be played on communication device 110. In the example, Jack and Jill are also “buddies”, members of community 150 who elect to share content with each other.

Community server 130 comprises a media clip selection database 132 which stores a collection of media clips 134 for selection by members of community 150. Jill accesses community server 130 via an Internet connection (arrow 131) and then selects a media clip 134 for her video ringtone.

A software client (not shown) on Jack's communication device 110 then downloads (arrow 133) Jill's media clip 134 to device 110. Communication device 110 comprises a media player 112, a personalization content manager 137, and buddy media clip database 138. Buddy media clip database 138 comprises media clips 136 which are copied versions of media clips 134 selected by Jack's buddies.

When Jill initiates a voice connection 140 from telephone 120 to Jack's communication device 110, personalization content manager 137 identifies her as one of Jack's buddies. Personalization content manager 137 then retrieves the media clip 136 originally selected by Jill and plays it as a video ringtone on media player 112, thus playing Jill's selected clip on Jack's phone when Jill calls, when Jack calls Jill or for any other trigger related to Jack and Jill.

### SUMMARY OF THE PRESENT INVENTION

It is an object of the present invention to provide a new form of digital rights management.

There is therefore provided, in accordance with a preferred embodiment of the present invention, a method including displaying content on a device of a viewer conditioned on a trigger associated with an owner of the content.

There is also provided, in accordance with a preferred embodiment of the present invention, a method including encrypting content owned by an owner with a viewer identifier belonging to a viewer and adding a viewing condition to the encrypted content, the viewing condition being at least a function of an identifier of the owner.

Additionally, in accordance with a preferred embodiment of the present invention, the displaying includes checking trigger information against an owner identifier followed by decrypting the content with a viewer identifier.

Moreover, in accordance with a preferred embodiment of the present invention, the identifiers are an associated telephone number, an encoded version of an associated telephone number, an international mobile subscriber identity number or an international mobile equipment identity number.

Further, in accordance with a preferred embodiment of the present invention, the trigger is a call-related trigger. It might be an incoming call from the owner, an outgoing call to the owner, a disconnect from a conversation with the owner, a busy/unavailable signal for the owner or a push signal from the owner.

Additionally, in accordance with a preferred embodiment of the present invention, the displaying includes retrieving owner information associated with a telephone number of a current call and a media clip associated with the owner, checking at least the owner information against owner information in the media clip, decrypting encrypted content in the media clip with a viewer identity if the result of the checking is positive and displaying the content.

Moreover, in accordance with a preferred embodiment of the present invention, the method includes processing the owner identifier prior to the checking.

There is also provided, in accordance with a preferred embodiment of the present invention, a system including a digital rights management unit and a media player. The digital rights management unit identifies a trigger associated with an owner of content. The media player displays the content on a device of a viewer upon instruction from the digital rights management unit.

There is also provided, in accordance with a preferred embodiment of the present invention, a system including an encrypter to encrypt content owned by an owner with a viewer identifier belonging to a viewer and a digital rights management unit to add a viewing condition to the encrypted content, the viewing condition being at least a function of an identifier of the owner.

Additionally, in accordance with a preferred embodiment of the present invention, the digital rights management unit includes means to check trigger information against an owner identifier followed by decrypting the content with a viewer identifier.

Further, in accordance with a preferred embodiment of the present invention, the identifiers are an associated telephone number, an encoded version of an associated telephone number, an international mobile subscriber identity number or an international mobile equipment identity number.

Still further, in accordance with a preferred embodiment of the present invention, the trigger is a call-related trigger. It might be an incoming call from the owner, an outgoing call to the owner, a disconnect from a conversation with the owner, a busy/unavailable signal for the owner or a push signal from the owner.

Moreover, in accordance with a preferred embodiment of the present invention, the digital rights management unit includes a data retriever to retrieve owner information associated with a telephone number of a current call and a media clip associated with the owner, a checker to check at least the owner information against owner information in the media clip and a decrypter to decrypt encrypted content in the media clip with a viewer identity if the result of the checking is positive.

Finally, in accordance with a preferred embodiment of the present invention, the digital rights management unit includes a unit to process the owner identifier prior to the checking.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a personalization content sharing system;

FIG. 2 is a schematic illustration of a method of sharing digital content with others, useful in the system of FIG. 1; and

FIGS. 3A and 3B are block diagram illustrations of one embodiment of the method of FIG. 2 within the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

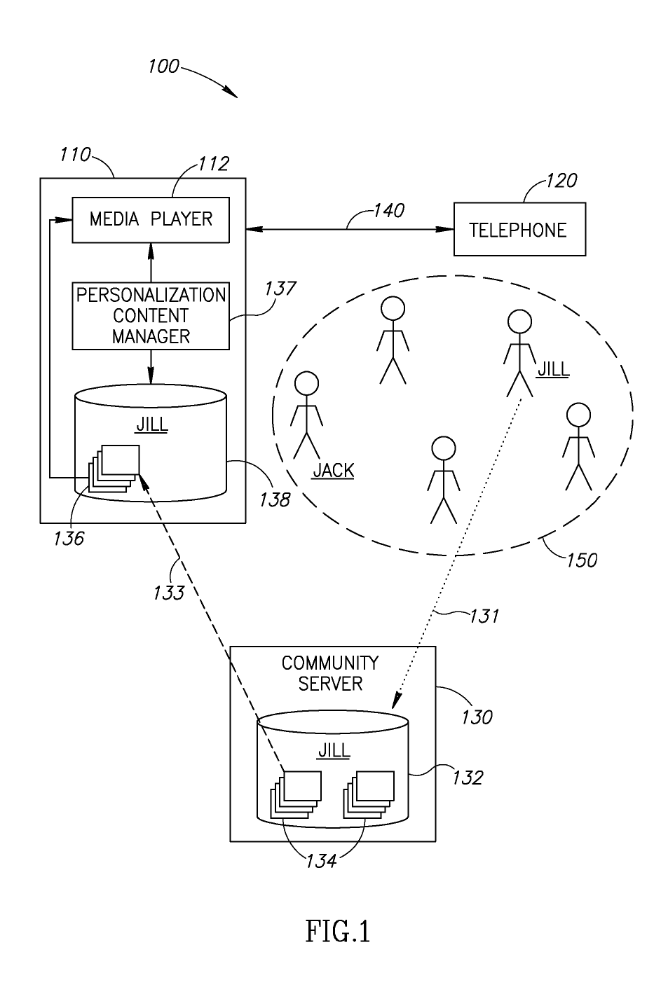

Applicants have realized that digital rights management (DRM) may be expanded to enable people to share their legally bought, digital content with others. In accordance with a preferred embodiment of the present invention, each person, an “owner”, may buy a license to the content and/or a license to share it with at least one other person, a “viewer”. The DRM of the present invention enables the viewer to generally securely open the content, but only upon a trigger from the owner. For example, for the system of FIG. 1, the trigger might be a calling event associated with the owner and the viewer (e.g. the owner calling the viewer or the viewer calling the owner). Alternatively, the trigger may be receipt of a message, such as an SMS (short message service), of a particular type from the owner.

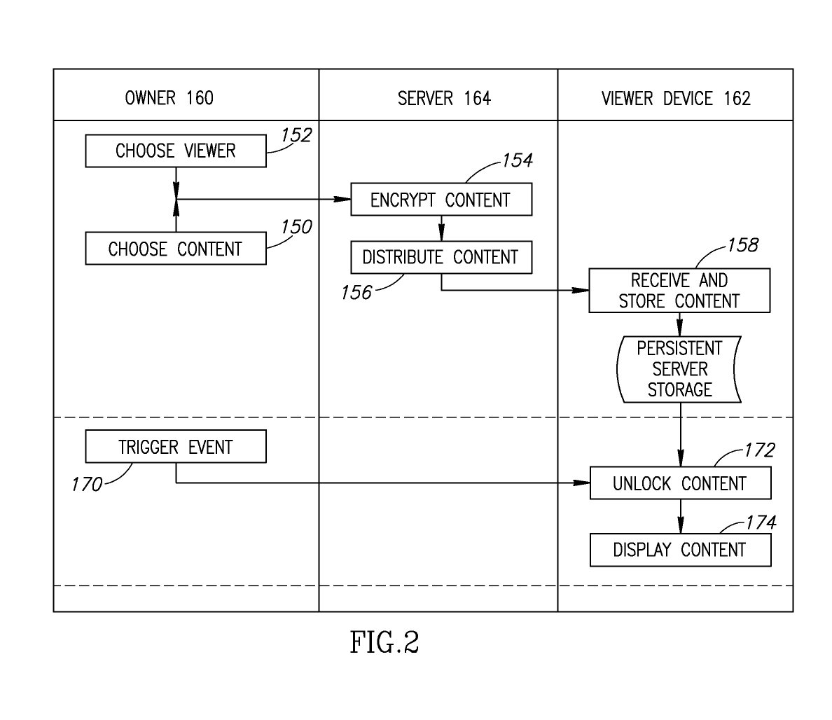

Reference is now made to FIG. 2, which illustrates a method of sharing digital content with others. FIG. 2 indicates which operations are performed by an owner 160, a device 162 of a viewer and a server 164 storing for the content. FIG. 2 also divides the operations into two steps, the content selection and the content display operations.

Owner 160 may first choose (step 150) the content to be shared, such as a video clip or similar media object. He may choose (step 152) the viewer (a friend, buddy, member of the same community, etc) with whom he wants to share the content. Owner 160 may select more than one viewer for each such piece of content. Owner 160 may indicate his choices to server 164 which may store and process the content. Any server, such as community server 130 of FIG. 1, may act as server 164.

Server 164 may encrypt (step 154) the content for each selected viewer and may condition the decryption on the receipt of a trigger from owner 160. Server 164 may distribute (step 156) the associated content to device 162 of each selected viewer, typically through an appropriate download process, such as the ones described in U.S. patent applications 60/771,883 and 60/772,564, now incorporated into U.S. Ser. No. 11/544,938.

It will be appreciated that the encryption may occur on a different server than the one which distributes the content. It might also occur on the owner's.

In step 158, device 162, which may be a mobile handset with appropriate client software and/or a desktop computer or other device, may store the received content. However, the viewer may only be permitted to view the content when owner 160 “triggers” permission.

For the system of FIG. 1, some triggers associated with the owner include:

Owner calls viewer: Alice (the owner) calls Bob (the viewer), which triggers the display of Alice's content.

Viewer calls owner: Bob calls Alice. The call to Alice triggers the display of Alice's content to Bob.

Disconnect: Bob and Alice finish talking. Either hangs up. The hangup is the trigger.

Busy/unavailable: Bob calls Alice. Alice's handset is busy or turned off. The trigger is the call to Alice and thus, Alice's content is displayed to Bob.

Push: Alice sends a push signal, to request that her content be delivered to Bob. The request includes the trigger. Bob sees the content immediately. The request may come in any kind of signal. For example, it may be an SMS; it may be a TCP or UDP network signal; it may be an infrared signal, such as exists for downloading between two PDAs (personal digital assistants), etc.

Given a trigger (step 170) from the owner, device 162 of the viewer may unlock (step 172) the content. With the content unlocked, viewer's device 162 may display (step 174) the content to the viewer.

It will be appreciated that, in the method of FIG. 2, the viewers may not own the content. They may not have the right to distribute the content further to their friends. They may not even have the right to play the content in any situation other than when triggered by the content owner.

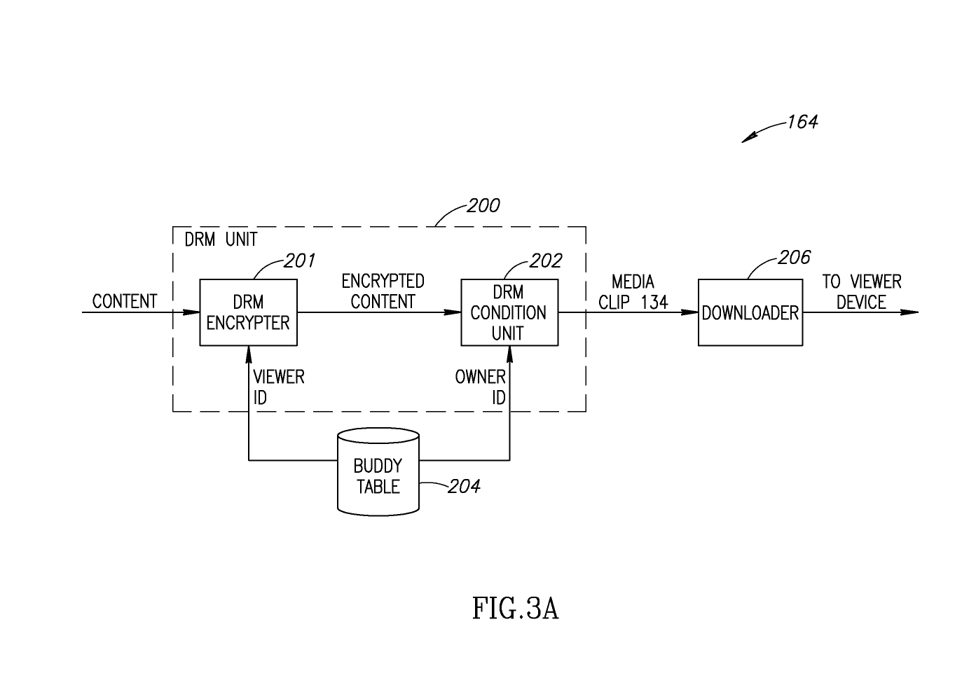

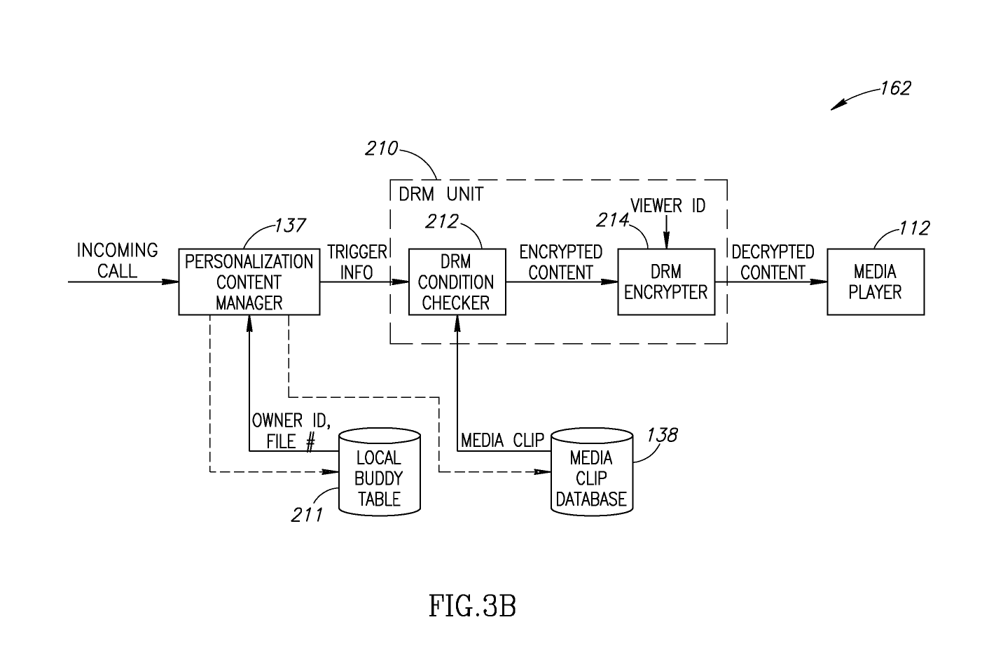

Reference is now made to FIGS. 3A and 3B. FIG. 3A details the elements of an exemplary server 164 operative to perform step 154 (encrypt content) and FIG. 3B details the elements of an exemplary viewer device 162 operative to perform step 172 (unlock content), constructed and operative in accordance with a preferred embodiment of the present invention, for the system of FIG. 1.

Server 164 comprises a DRM unit 200, a buddy table 204 and a downloader 206. DRM unit 200 comprises a DRM encrypter 201 and a DRM condition unit 202. DRM encrypter 201 may be any suitable DRM encoder, which may encrypt input content (e.g. a media clip 134) given an encryption key. In accordance with a preferred embodiment of the present invention, DRM encoder 201 may utilize a viewer identifier, stored in buddy table 204, as the encryption key.

When encrypting for a particular viewer, server 164 may request the viewer identifier from buddy table 204, which, as described in U.S. Ser. No. 11/544,938, may store various information about the members of the community, including their names and some identification of their devices. In accordance with the present invention, the viewer identification is the telephone number. In another embodiment, it may be an encoded version of the telephone number. In accordance with a preferred embodiment of the present invention, the viewer identifier may be securely coupled to the viewer's identity or that of his playing device, such as the GSM “International Mobile Subscriber Identity” (IMSI), the “International Mobile Equipment Identity” (IMEI) identifier, or any other suitable identifier of the user or his device.

DRM condition unit 202 may add a viewing condition into the file storing the encrypted content. In accordance with a preferred embodiment of the present invention, the viewing condition may be a call-related trigger from owner 160 and thus, the condition may be defined with some identification of owner 160. Once again, the identification may come from buddy table 204 and may be the telephone number, an encoded version of the telephone number, the GSM “International Mobile Subscriber Identity” (IMSI), the “International Mobile Equipment Identity” (IMEI) identifier, or any other suitable identifier of the user or his device. However, this time, it is for the owner.

DRM condition unit 202 may also process the owner identifier in any suitable way, such as by encrypting it or hashing it, prior to adding the result into the file containing the encrypted content.

As in U.S. Ser. No. 11/544,938, downloader 206 may download the output of DRM unit 200 as a media clip 136 to viewer's device 162, at an appropriate time. At the same or a different time, downloader 206 may provide the owner identifiers to viewer's device 162, typically during an update of buddy information.

Viewer device 162 comprises, in addition to personalization content manager 137, media clip database 138 and media player 112 of FIG. 1, a DRM unit 210 and a local buddy table 211. DRM unit 210 comprises a DRM condition check unit 212 and a DRM decrypter 214.

As discussed in U.S. Ser. No. 11/544,938, personalization content manager 137 may determine when telephone calls are being made and/or received and may determine the telephone number of the call. Manager 137 may provide this call information to local buddy table 211 to retrieve both the owner identifier associated with the telephone number and the name of media clip 136 associated with the owner. Manager 137 may then provide the owner identifier and the clip name to DRM condition checker 212 and may indicate to database 138 to provide associated media clip 136 belonging to the owner to DRM checker 212. Manager 137 may also indicate the type of telephone call (whether incoming or outgoing).

DRM checker 212 may review the condition information stored in media clip 136 and may check the information against the owner identifier and any other call-related information it received from personalization content manager 137. It may decrypt the owner identifier, or hash it, or process it in any suitable way, in the reverse of what was done by DRM condition unit 202.

DRM checker 212 may remove the condition and pass the file to DRM decrypter 214 only if suitable, predefined conditions exist, such as that the call is to or from owner 160. Additional conditions may include the type of call, such as only for an incoming or only for an outgoing call.

If the file is passed, DRM decrypter 214 may utilize the viewer identifier, which may be maintained by viewer device 162, to decrypt the content, in a reverse process to that of DRM encrypter 201. DRM decrypter 214 may then provide the decrypted content to media player 112, which may then display the decrypted content to the viewer.

It will be appreciated that the viewer may not view media clip 136 without DRM unit 210 first processing it since media player 112 may not be able to read media clip 136, which contains the condition information.

It will further be appreciated that system of FIGS. 3A and 3B operates with a call-related trigger. In an alternative embodiment, personalization content manager 137 may check for other types of triggers from owner 160. For example, the trigger may be an SMS of a particular type.

It will still further be appreciated that the present invention may be implemented in other systems and for other types of triggers from owner 160.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
conditioned on a trigger associated with an owner of content, displaying said content on a device of a viewer.

2. The method according to claim 1 and wherein said displaying comprises checking trigger information against an owner identifier followed by decrypting said content with a viewer identifier.

3. The method according to claim 2 and wherein said identifiers are one of the following: an associated telephone number, an encoded version of an associated telephone number, an international mobile subscriber identity number and an international mobile equipment identity number.

4. The method according to claim 1 and wherein said trigger is a call-related trigger.

5. The method according to claim 4 and wherein said trigger is one of the following triggers: an incoming call from said owner, an outgoing call to said owner, a disconnect from a conversation with said owner, a busy/unavailable signal for said owner and a push signal from said owner.

6. The method according to claim 4 and wherein said displaying comprises:
retrieving owner information associated with a telephone number of a current call and a media clip associated with said owner;
checking at least said owner information against owner information in said media clip;
decrypting encrypted content in said media clip with a viewer identity if the result of said checking is positive; and
displaying said content.

7. The method according to claim 6 and comprising processing said owner identifier prior to said checking.

8. A method comprising:
encrypting content owned by an owner with a viewer identifier belonging to a viewer; and
adding a viewing condition to said encrypted content, said viewing condition being at least a function of an identifier of said owner.

9. The method according to claim 8 and wherein said identifiers are one of the following: an associated telephone number, an encoded version of an associated telephone number, an international mobile subscriber identity number and an international mobile equipment identity number.

10. The method according to claim 8 and wherein said viewing condition is a call-related trigger.

11. The method according to claim 10 and wherein said trigger is one of the following triggers: an incoming call from said owner, an outgoing call to said owner, a disconnect from a conversation with said owner, a busy/unavailable signal for said owner and a push signal from said owner.

12. A system comprising:
a digital rights management unit to identify a trigger associated with an owner of content; and
a media player to display said content on a device of a viewer upon instruction from said digital rights management unit.

13. The system according to claim 12 and wherein said digital rights management unit comprises means to check trigger information against an owner identifier followed by decrypting said content with a viewer identifier.

14. The system according to claim 13 and wherein said identifiers are one of the following: an associated telephone number, an encoded version of an associated telephone number, an international mobile subscriber identity number and an international mobile equipment identity number.

15. The system according to claim 12 and wherein said trigger is a call-related trigger.

16. The system according to claim 15 and wherein said trigger is one of the following triggers: an incoming call from said owner, an outgoing call to said owner, a disconnect from a conversation with said owner, a busy/unavailable signal for said owner and a push signal from said owner.

17. The system according to claim 15 and wherein said digital rights management unit comprises:
a data retriever to retrieve owner information associated with a telephone number of a current call and a media clip associated with said owner;
a checker to check at least said owner information against owner information in said media clip; and
a decrypter to decrypt encrypted content in said media clip with a viewer identity if the result of said checking is positive.

18. The system according to claim 17 and wherein said digital rights management unit comprises a unit to process said owner identifier prior to said checking.

19. A system comprising:
an encrypter to encrypt content owned by an owner with a viewer identifier belonging to a viewer; and
a digital rights management unit to add a viewing condition to said encrypted content, said viewing condition being at least a function of an identifier of said owner.

20. The system according to claim 19 and wherein said identifiers are one of the following: an associated telephone number, an encoded version of an associated telephone number, an international mobile subscriber identity number and an international mobile equipment identity number.

21. The system according to claim 19 and wherein said viewing condition is a call-related trigger.

22. The system according to claim 21 and wherein said trigger is one of the following triggers: an incoming call from said owner, an outgoing call to said owner, a disconnect from a conversation with said owner, a busy/unavailable signal for said owner and a push signal from said owner.
